(19) United States
(12) Patent Application Publication
(10) Pub. No.: US 2016/0232472 A1
(43) Pub. Date: Aug. 11, 2016

(54) SYSTEM AND METHOD OF HEALTH CARE MANAGEMENT FOCUSED ON PHYSICIAN ENHANCEMENT

(71) Applicant: Remedy Indiana, Inc., Indianapolis, IN (US)

(72) Inventors: Eugene Henry Lamkin, JR., Indianapolis, IN (US); Ralph Alexander, Columbus, IN (US); David Axene, Winchester, CA (US)

(21) Appl. No.: 15/016,508

(22) Filed: Feb. 5, 2016

Related U.S. Application Data
(60) Provisional application No. 62/113,284, filed on Feb. 6, 2015.

(51) Int. Cl. G06Q 10/06

(52) U.S. Cl. CPC G06Q 10/06398; G06Q 50/22

(57) ABSTRACT

The present invention involves a method for improving physician performance in measured areas. A quantitative measure of a type of physician is established, the quantitative measure including compiling statistical data of such quantitative measures for the type of physician and calculating at least one threshold statistical value. The particular physician is monitored relating to the quantitative measures of the physician's type. A score is calculated relating to the particular physician for comparison to the threshold statistical value. An action is performed relating to the particular physician based on a comparison of the calculated score and the threshold value. If the comparison results in determining that the calculated score exceeds the threshold value, the action taken includes enhancing compensation. If the comparison results in determining that the calculated score is below the threshold value, the action taken includes providing an improvement plan to the particular physician. The monitoring step involves extracting clinical data from medical records relating to a medical care incident of the particular physician including recorded results of medical diagnostic testing.

### CROSS-REFERENCE TO RELATED APPLICATIONS

The present application claims priority under 35 USC 119(e) of U.S. Provisional Patent Application Ser. No. 62/113,284, filed Feb. 6, 2015, entitled “Physician Self-Management for Continuous Quality Improvement & Cost Effectiveness”, the disclosures of which are incorporated by reference in their entirety herein.

### BACKGROUND OF THE INVENTION

1. Field of the Invention

The field of the invention is that of systems and methods for quality management and improvement for health care providers in general and physicians in particular.

2. Description of the Related Art

No one is happy with health care today. Employers are concerned about cost; employees about limited options and increased cost; physicians about hassle, decreasing professional autonomy and compensation; hospitals about constant pressure for deeper discounts perceived as contributing only to insurance company profits; and government about access and cost.

A major focus of “medical management” in the last few decades has been on costs. Attempts to control them have relied primarily on: (2) Pressing for ever greater price discounts from hospitals and physicians; (2) Increased patient cost sharing with ever-larger front-end umbrella deductibles and co-payments; (3) Consumer Directed Health Plans expecting a patient, with more information on medical care alternatives, to choose the best medical care option; and (4) Case-by-case pre-treatment permissions before high cost or commonly overused diagnostic or medical treatment procedures are authorized or certified as Covered Services for full benefit payment. Each of these historical and contemporary Managed Care Solutions have had very limited long-term impact on reducing cost and practically no effect on improving the quality of healthcare services for the following reasons.

Medical Provider Price Discounts. Employers have most readily pursued negotiations for lower administration cost (less than 5% of the total cost of health plans) and market pressure to leverage a discounted unit price from hospitals, physicians, and other medical providers. Pressure for medical provider discounts has tended to result in marking up the “sticker price” before reluctantly agreeing to a significant discount request. Too often, the primary pressure by market-share dominant health plans has been to obtain a differential or price advantage over smaller competitors tending to inflate undiscounted unit prices. Another result has been for the estimated 25% of the public not enrolled in any kind of “managed care” medical provider network to pay the inflated pricing that is perhaps 20% to 50% more than the “usual charge” accepted for the 75% of patient volume who are covered by network provider discounts.

Increased patient cost sharing with ever-larger front-end umbrella deductibles and co-payments. Requiring insured persons to bear more and more of the cost of health care despite ever-increasing monthly premiums and employee cost-sharing for those in Group Plans has maxed out. It is very common for a health plan to require the consumer to first pay $2500 to $5000 out-of-pocket before receiving any healthcare benefits. The recently enacted Affordable Care Act has been much more about increased access to health plan coverage, prohibiting denial of coverage or premium surcharges for pre-existing medical conditions than it has been about addressing the cost effectiveness of healthcare services.

Consumer Directed Health Plans (CDHP). The purpose of high deductible, CDHPs is to discourage unnecessary health care consumption and assumes consumers will make healthcare purchasing and medical treatment options that are in their own self-interest and that they will avoid costly and poor quality medical care (if only they had access to medical education). There has been some decrease in current use and cost, but it may result in greater health care needs and cost over time. One primary problem has been the inherent inability of a typical consumer to assess properly what may be the best approach to diagnosis or treatment of his or her own medical condition. Consumer health-information telephone assistance programs have had well less than 15% use by those having and potentially benefitting from these cost-free resources.

Another major drawback is that 5% of the population consumes 50% of the healthcare benefit dollars (and 20% consumes 80%). In these situations, comprising half or more of healthcare spending, the typical consumer has difficulty sorting out options and tends simply to follow the attending physician's orders, having very little ability to understand alternatives, or (and even less desirable) fails to obtain necessary care, which may lead to more need and higher cost later according to a recent online survey conducted by Harris Poll on behalf of SCIO Health Analytics. According to the survey, 1 in 5 (44 million) insured Americans have avoided a doctor visit in the past year due to cost concerns. In addition, approximately half of US adults (117 million) have at least one chronic condition. Further, 14% (16.4 million) of the chronic population have deferred healthcare in the past year due to cost concerns.

Patient education is best focused on how to maintain a healthy life style with incentives to form good health habits. CDHPs have resulted in less claim dollars being wasted for elective medical care and some success by some of the consumers in pricing out medical care services perceived to be of equal value by the consumer (may not be of comparable value). But CDHPs have not made a meaningful difference in promoting either the quality or cost effectiveness of medical care, and could increase cost over time.

Transparency of unit price cost and reliable indicators of a physician's or other Medical Provider's relative quality should not be completely discarded but it is futile to expect a patient to have sufficient medical knowledge to direct their own medical care. If they could do so, they would be called “Doctor”.

Case-by-Case pre-treatment authorizations and certifications Third-party intervention efforts on a pre-treatment, case-by-case approach are of marginal value as denials tend to only impact on physicians with medical practice patterns that are 1.5 to 2.0 standard deviations from the norm, a very small percentage of the total medical community. Such a limited impact cannot hope to alter the ever increasing $/Employee/Month cost trend. These failed approaches include: (1) pre-authorizations & pre-certifications, (2) concurrent utilization management required to authorize continuation of an ongoing medical care mode, e.g. hospital stay, and (3) Case Management that is not structured as an extension of the attending physician's medical management of the patient.

These attempts to make third-party medical management more aggressive are: Severely hampered by the remoteness of the Physician Reviewer making detailed insight into the patient's medical condition very difficult, Resented by the insured, Frequently the cause of delays in needed medical care being received, sometimes for many months, A growing litigation risk when a patient dies not having received the medical care prescribed by the attending physician because medical plan benefits were denied. This very real risk of litigation commonly results in initial denials of medical care being reversed upon appeal with the associated delay in needed care and potential adverse impacts from it.

The two most recent developments in Managed Healthcare efforts are: “Narrow Networks” with variable criteria employed by health plans to determine which physicians and hospitals are to be included in the Narrow Network. These criteria are not commonly set forth for the health plan purchaser or the patient. Many surmise that deeper discounts may be a dominant factor in the provider choice or that the medical provider is required to accept a transfer of underwriting risk from the health plan to the provider. A primary problem with Narrow Networks is the inability for a small part of a community's medical delivery system to serve the medical needs of the entire population. In many communities there is already a shortage of certain needed physician specialties, especially primary medical care. Rating physicians in a medical provider network according to quality and efficiency standards. This approach perhaps is best classified as a CDHP strategy. The health plan asserts it will help the consumer pick a physician by public disclosure in the medical provider directory that an individual physician: “Has/Has Not met quality standards”, “Has/Has Not met efficiency standards”, or “Not enough data to evaluate/not evaluated”

There are several problems with this approach by health plans: Variable evaluation criteria among plans so that the same physician is at risk for being publically labeled as being of inferior quality by one health plan and at the same point in time listed as having met quality standards by a different national carrier. The primary reliance of these evaluations appears to be analysis of paid claims data that is morbidity adjusted for the same “market basket” of patient morbidity and whether the physician is determined to routinely meet HEDIS-type quality of care measurements. Both of these are useful tools but are inadequate without other critical evaluations and comparisons to evaluate the quality and efficiency of a physician's overall medical practice pattern. Paid claims date alone is always “not enough data to evaluate” (see above) and because: Does not include clinical data; Linkage of an individual physician with the cost and utilization of a given patient is problematic with PPO products that do not require a patient to select a personal physician. Instead they rely on “attribution”; Paid claims data does not capture in the denominator those patients of a physician generating no paid claims data in a given period of time; Does not have an adequate audit trail or discussion with the physician as to the accuracy of the paid claims analysis. Finally, Health plans (including large, national plans) are not qualified to make evaluations of a physician's quality or efficiency because of: Conflict of interest, especially publically-traded companies, being more concerned about cost than quality; Discussion and interface with the physician is best accomplished at a local community level; Proprietary interests prevent full disclosure of evaluation methodology and detailed examination and discussion with the physician of those specific factors driving apparent significant variations in paid claims data from the norm.

### SUMMARY OF THE INVENTION

The systems and methods of the present invention relate to providing feedback to physicians on physician's treatment of patients to enable the physicians to understand best practices in treatment options. These systems and methods monitor individual physician treatments and compare to trusted treatment procedures and notify individual physicians regarding alternative treatment methods. In this way, an automated and impartial feedback is provided to the physician who may then be enabled to consider alternative treatments that may be appropriate.

There is a well-documented medical waste factor present in the typical medical community of 30% to 40% (some estimates are higher) of health plan benefit dollars being expended on useless or marginal value medical care services. And too many patients are not getting an accurate diagnosis or best medical treatment for their specific medical condition.

There are many factors contributing to this severe problem of poor quality and poor value medical care, but a dominant factor is documented variation in medical practice patterns among physicians of the same specialty treating patients of very similar medical condition.

The 20% Best Physicians use about 40% to 50% less healthcare benefit dollars, with a population denominator, than the 20% ranked at the bottom

These 20% Best Physicians use about 20% less healthcare dollars, with a population denominator, than the average Physician.

There is an embedded medical waste factor of 30% to 35% in the most common medical practice patterns of physicians in a medical community. The clear implication is that the quality and value of medical care in a medical community may best be addressed by focused efforts on improving the quality and cost effectiveness of the average medical practice pattern while not neglecting to correct the medical practice patterns of the relatively small percentage of physicians who have a medical waste factor of 50% or more.

In one aspect, the present invention involves a method for improving physician performance in measured areas. A quantitative measure of a type of physician is established, the quantitative measure including compiling statistical data of such quantitative measures for the type of physician and calculating at least one threshold statistical value. The particular physician is monitored relating to the quantitative measures of the physician's type. A score is calculated relating to the particular physician for comparison to the threshold statistical value. An action is performed relating to the particular physician based on a comparison of the calculated score and the threshold value. If the comparison results in determining that the calculated score exceeds the threshold value, the action taken includes enhancing compensation. If the comparison results in determining that the calculated score is below the threshold value, the action taken includes providing an improvement plan to the particular physician. The monitoring step involves extracting clinical data from medical records relating to a medical care incident of the particular physician including recorded results of medical diagnostic testing.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic view of one embodiment of the present invention.

FIG. 2 is a flow chart diagram of one embodiment of the method of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF EMBODIMENTS OF THE PRESENT INVENTION

The embodiments disclosed below are not intended to be exhaustive or limit the invention to the precise forms disclosed in the following detailed description. Rather, the embodiment is chosen and described so that others skilled in the art may utilize its teachings.

In one embodiment, the invention, Physician Self-Management for Continuous Quality Improvement and Cost Effectiveness (PSQE), is a strategy and process, along with a detailed operational plan, for achieving and maintaining an optimum level of quality healthcare services and cost effectiveness through a self-managed program of physician assessment and improvement. PSQE does this by perfecting the process of healthcare delivery rather than individual physician/patient interactions, medical procedures, or medical conditions. Systems implementing this process accumulate data from health care providers regarding the procedures and processes individual physicians use for various treatments on all their patients. The systems compile the data and analyze each individual physician's treatment patterns in relation to threshold levels of treatments for similarly situated patients. While each individual situation may from time to time deviate from the norm, by monitoring the entire range of treatments that a physician makes over an entire range of patients provides a pattern, and an analysis of that pattern may allow for statistically significant conclusions to be drawn. When an individual's physician's pattern of treatment is derived from a large volume of patient treatments then the pattern of treatment selections may be meaningfully compared to an ideal of best practice treatments.

PSQE is premised on the understanding that the physician is in control of virtually all medical care decisions with the tacit or formalized agreement of the patient. The physician directly provides, orders, arranges, or refers the patient to other physicians or medical care providers. The repeating medical practice patterns of the physician are the single most important factor in the process by which medical care is delivered in a medical community. Medical practice patterns drive the quality and cost effectiveness of healthcare services for which health care dollars are a major sources of funding. Therefore, the individual physician's medical practice pattern is the proper focus of PSQE.

There is a well-documented variation in medical practice patterns among physicians of the same specialty within the same geographic area when serving patients with very similar medical conditions. The degree of variation borders on being a national scandal. The 20% Best Physicians use about 40% to 50% less healthcare benefit dollars, with a population denominator, than the 20% ranked at the bottom. These 20% Best Physicians use about 20% less healthcare dollars, with a population denominator, than the average physician. There is an embedded medical waste factor of 30% to 35% in the most common medical practice patterns of physicians in a medical community.

This variation in medical practice patterns has heretofore defied all efforts by the managed care industry to reduce the degree of variation in favor of improved quality and attendant cost-effectiveness. Most of these efforts have attempted to solve the problem by externalized pressures and third party (to the physician and patient) interventions on a case-by-case basis. Those few exceptions designed to take into account the master control role of the physician have had some success but have not been such that they could be replicated across the US for one reason or another.

PSQE is designed and structured on the following principles: 1. All parties to the solution must be engaged on an entirely voluntary basis with no coercive penalties: physician, patient, employer. 2. No single party to the solution must “win” at the expense of another party. 3. Physicians are overwhelmingly (90%) motivated to provide the best clinical care for their patients to achieve optimum health status for their age and medical condition(s). 4. The entire medical community is the target for improved medical quality and cost effectiveness, not a narrow subset of physicians. 5. Traditional pre-certification and pre-authorization of medical care on a case-by-case basis is of very minimal value that does not warrant the expense and aggravation to physician and patient alike. PSQE sharply limits the incidence of pre-notification (not benefit authorization) to only those situations where patient safety or negative impact on medical outcome is at issue and the PSQE approach is to make sure the attending physician is fully informed about the latest Best Practices/Quality Standards as determined by clinical leadership in his own specialty. 6. Physicians generally are not amenable to externalized efforts to force changes in medical practice behavior and will only revise his/her medical approach when he/she comes to believe there is a better way—better medical outcomes or the same medical outcome for significantly less use of health plan dollars. 7. Physicians will come to understanding that there is a better medical approach when clinical leadership in their same specialty, respected for their clinical expertise, point to a better approach. 8. Physician self-management is THE approach to reducing the variation in medical practice patterns in a medical community, within the same specialty. 9. Clinical excellence should be promoted and rewarded by physicians who are among the best in their respective specialty sharing in the savings created by their medical practice patterns. All physicians who complete evaluation of their medical practice patterns and are ranked at or above the highest standard receive 1.20 of the fee schedule for their services, otherwise payable at 1.00.

The Physician Quality Alliance (PQA) is the name given to an organization which is vested with the authority for all definitions of what constitutes quality medical care, best medical practices in the diagnosis and treatment of illness and injury, for example as an outgrowth of an existing physician related organization (e.g., the American Medical Association) or as an independent organization specifically for this purpose. It places this authority where it properly belongs: in the PQA and its 30-32 PQA specialty panels, each of which may be statewide, composed of recognized clinical leaders in each specialty, and has geographic representation.

Each PQA Specialty Panel is vested with the authority and accountability for: Definition of Quality Medical Care Decisions; Evaluation of the medical practice patterns of all individual physicians expressed in a Quality-Efficiency Index (Q-E Index) being an actuarial estimate of how many healthcare benefit dollars will be required to fund the medical practice pattern of each individual physician for the same patient morbidity; Mutual development of a Quality Improvement Plan (QIP) for those physicians with a Q-E Index that falls below the minimum of 0.70 and monitoring the progress and completion of the QIP within a mutually agreed upon, reasonable period of time; Determination that an individual physician has not met his PQA Membership Agreement to maintain a Q-E Index of 0.70, after due process, and failure to execute in a timely manner that physician's QIP; Recommend to employers protocols and incentives designed to promote engagement of employees in adopting healthier life styles and full compliance with medical interventions, specific to each specialty and chronic illness; and Development of Case Management strategies and protocol, specialty specific, that integrates Case Management with the attending physician's office functioning as an extension of the physician's office rather than an interfering and annoying third party. Members of these each PQA Specialty Panel, in one embodiment, are selected through a survey of physicians. First the results from members in a specific specialty identifies a small number of physicians who are, by consensus, deemed to be the clinically most highly respected for their expertise. These physicians are then matched with results from all other physicians as an indicator of which of these acknowledged experts relate most effectively with physicians outside of their specialty.

The Quality-Efficiency Index is a single number that denotes the degree of variation of this physician's medical practice patterns (process by which medical care is delivered to that physician's patients) from optimum medical care as it is known today by recognized clinical leadership in that same physician specialty (also called Best Practices, Gold Standard, Highest Quality Standards, etc.). A Physician's medical practice pattern is multi-dimensional and many physicians are apt to have a variable performance for different medical practice dimensions. The PQA Panel has the task of evaluating overall performance. The degree of variation from the optimum (gold standard) medical practice pattern is a reliable barometer that allows an actuarial estimate of how much each individual physician's medical practice pattern varies from the average use of health plan benefit dollars (expressed as $ per member/per month) for the same patient morbidity (expressed as a morbidity index) within the same medical community.

The specific components the feed into a Quality-Efficiency Index are generally governed by: Determination of the metrics that are most relevant for this physician specialty; Methods for consistently accessing these metrics; The relative importance of each metric, e.g. proper use of inpatient hospital days; The Q-E Index is expected to have a confidence limit in excess of 80% with respect to predicting the use of medical care resource in caring for the same patient morbidity index.

All physicians are initially evaluated for a Quality-Efficiency Index (Q-E Index) by the PQA and those physicians with a Q-E Index of 0.80 or higher are eligible for 1.20 of the fee schedule for their own medical services. Those physicians with a Q-E Index below 0.70 have a mandatory Quality Improvement Plan (QIP) mutually developed with his/her QPA Specialty Panel that also monitor progress in accomplishing the QIP. These possible outcomes in the process are represented as Perform Action depending on Comparison 208 in FIG. 2. Failure to achieve a minimum of a 0.70 Q-E Index results in termination of the physician's membership in the Physician Quality Alliance (PQA).

To produce the Q-E Index, the medical practice patterns of the individual physician are evaluated with reference to the degree of variation from the optimum. The optimum may be defined as the best-known approach to the diagnosis & treatment of illness and injury as well as maintaining the optimum health status for the patient taking into account the age, gender, health history, and any chronic medical conditions. The optimum is described the medical practice patterns of the top 20% of the leading clinicians in each physician's own medical specialty. It is understood that medical science is always advancing in content and method. As such, what constitutes optimum diagnosis, treatment, and well care is a moving target.

The highest quality health care is also the least expensive when measured over an entire enrolled population. Poor quality health care is characterized by some or all of the following (not a complete list): Wrong diagnosis or avoidable delay in reaching a correct diagnosis; Wrong treatment plan for the correct diagnosis; Excessive or an incorrect mix of diagnostic procedures and testing; Surgery that is not indicated for the correct Diagnosis; Surgery that is poorly performed with corrective surgery required or complications resulting in additional cost and negative medical impact on the patient; Wrong intensity or mix of diagnostic tests/procedures and/or medical treatment; Prescription medication that is not the best therapy for the patient's correct Diagnosis—wrong medication, dosage, or frequency; Medical care rendered in a less-than-ideal setting, such as inappropriate use of inpatient hospital services, ambulance, emergency room; Not referring a patient for specialty physician services when indicated; Referring a patient to a specialty physician when not indicated.

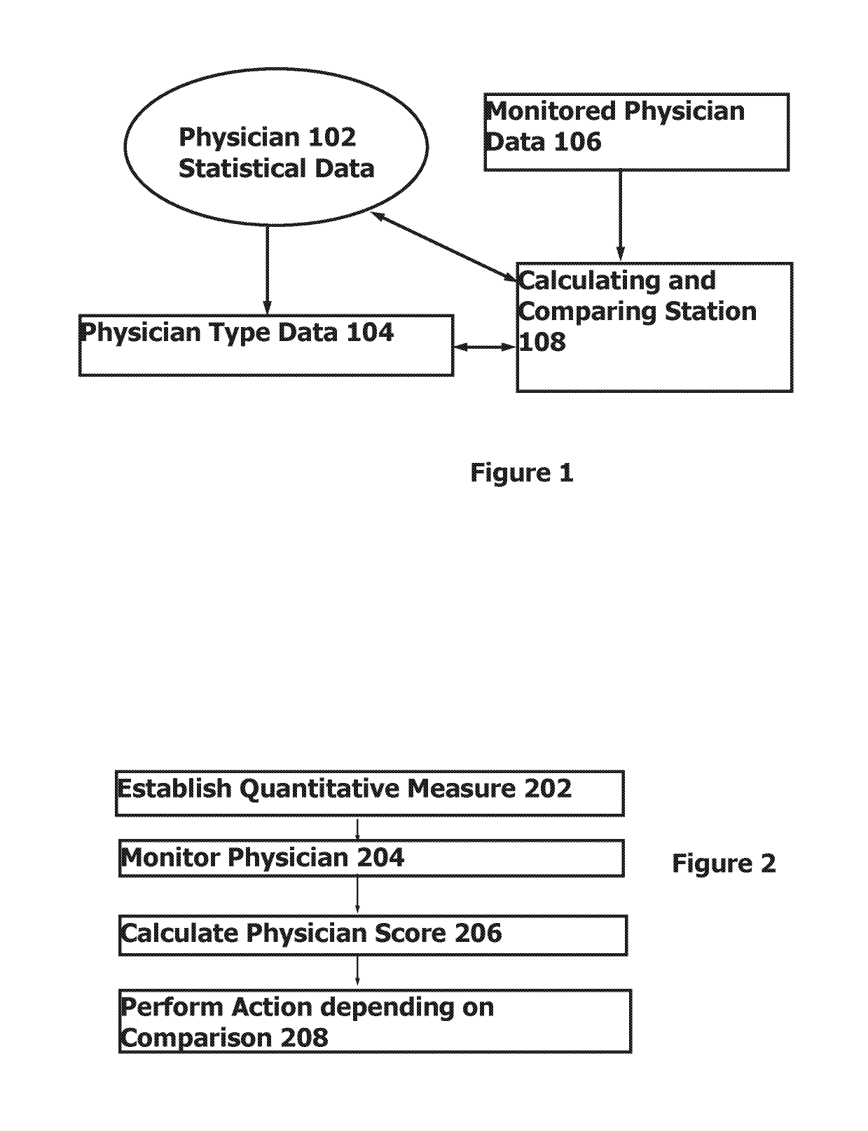

Medical practice patterns may be inferred, observed, and measured with using at least the following source metrics: Morbidity adjusted cost and utilization paid claims data for an enrolled population requiring linkage of specific patients and specific physicians (PSQE makes use of analytics software to analyze historical data, for example without limitation the MEDai or Symmetry software packages—It is noted that PSQE's use of paid claims data is only to identify apparent variations from the norm, good and bad, for additional analysis with reference to all other Q-E metrics selected by the PQA Specialty Panel.); Clinical data that may be extracted from a focused sample of the medical records created incident to medical care delivery including the recorded results of diagnostic testing and procedures; Physician medical chart notes with details about the patient's history and physical, exam findings, and all other recorded information useful by the physician and other physicians for continuing care; Medical Outcome analysis of patients served; Physician self-description of his/her own medical practice patterns in response the different kinds of patients and medical issues common to each physician specialty. Such data is represented in FIG. 1 as Physician Statistical Data 102, which may be initially entered by hand-written notes, voice recordings or transcripts, or other physical media and eventually tabulated into a form adapted for processing and manipulation by a computer, e.g., a database.

The specific metrics for each physician specialty are as determined by each PQA Specialty Panel, which is represented in FIG. 1 as Physician Type Data 104, and this step in the process as Establish Quantitative Measure 202 in FIG. 2. Again, the initial compilation of the specific metrics may be created manually or by discussion, with the ultimate results being tabulated into a form adapted for processing and manipulation by a computer, e.g., a database. The relative importance of each metric is also as determined by each PQA Specialty Panel, e.g. prescription drug utilization patterns may be twice as important for a Family Practice physician as it is for a General Surgeon. The PQA panels, in some embodiments, are formed with statewide representation, although regional and national representations may alternatively be used. PQA Panel Physicians are chosen from PQA member physicians who are actively engaged in clinical practice. Formation of the Committees must be secondary to PQA membership being offered in a medical community.

The metrics are collected, organized and summarized by Q-E Analysts who receive direction and guidance from the Chair of each PQA specialty Panel, this step in the process represented as Monitor Physician 204 in FIG. 2. The metrics are arrayed in a consistent format for all physicians in each specialty designation reflecting the distribution of each metric. The PQA Specialty Panel has the accountability for the Q-E Index determination after review of the tentative Q-E Index and all supporting details, represented in FIG. 1 as Calculating and Comparing Station 108, and as the step of Calculate Physician Score 206 in FIG. 2. A conventional data processing computer may be used to perform the numerical analysis on the metrics and tables previously described. In addition, systems operating according to the present invention compile a combination of data for each individual physician which includes the calculated Q-E Index and the supporting medical documentation. The system allows a fully developed protocol for Physicians not in full agreement with the Q-E Index to meet with the PQA Specialty Panel for collegial discussion and potential modification of the Q-E Index based on clarifying or additional information, and the system provides for both the PQA Specialty Panel and the physician to have both the index values and supporting medical documentation for review.

Each physician receives a written summary of his/her Q-E Index as well as: (1) Each metric that, with that metric's relative weight, composites to the Quality-Efficiency Index, represented in FIG. 1 as Monitored Physician Data 106. There is an audit trail for each metric that may be accessed by the physician receiving the Q-E Index; (2) What specific changes in medical practice patterns are expected to result in improved quality and cost efficiency of medical care services—specific and actionable; and (3) All of the entire Q-E process is archived and preserved for a minimum of 10 years and may be easily reproduced as needed. In FIG. 1, various data gathering and data processing portions of this embodiment of the system of the present invention are depicted. In one embodiment, each data collection location has a separate computer system for tabulating PQA Specialty Panel weightings. In one embodiment, a server is used to collect both the individual physician data and the PQA Specialty Panel weightings, so that all the data and tables are centrally accessible and capable of being processed. In several embodiments of the invention, such a server, whether a single computer or a complex of computers, compiles a unique combination of tabulated and indexed individual physician data along with the associated medical documents relevant for the evaluation of the tabulated number.

The PSQE may be applied in any medical community across America. The strategy and operating detail require very minimal adjustments for full implementation. Important operational tools for successful application of PSQE include: A management company that fully understands and operates on the tools and information used by the PQA Specialty Panels to make decisions. The management company also ideally completes its work on a timely and effective basis; Claims processing system ideally has at least the operating dexterity and functional capability as the standards for the industry; A morbidity-adjusted cost and utilization reporting capability for each individual physician. These tools are used as pointers to focus analytical analysis on significant variations from the norm, good and bad, to determine by more complete development for the PQA Specialty Panel the drivers of observed variations from the norm; Data Warehouse capability to aggregate and maintain all information relevant to the Q-E metrics selected by each PQA Specialty Panel; Medical Chart Review capability is required to drill down as needed to understand the actual medical practice pattern; Default Q-E metrics as the starting point for the PQA specialty Panel's selection and weighting of each selected Q-E metric used to compare individual physician's medical practice pattern; A detailed audit trail is ideally maintained for all aspects of developing the Q-E Index; Properly staffed and well-trained field interface capacity, which is important to foster discussion of the Q-E Index in detail with the attending physician, capture the self-description of medical practice patterns, etc.; and Chair of each PQA Specialty Panel serves as a Specialty Physician Consultant between PQA Specialty Panel meetings, ideally properly compensated for time.

The medical practice patterns of the individual physician are evaluated with reference to the degree of variation from the optimum. The optimum may be defined as the best-known approach to the diagnosis and treatment of illness and injury as well as maintaining the optimum health status for the patient taking into account the age, gender, health history, and any chronic medical conditions. The optimum may also be described as the medical practice patterns of the top 20% of the leading clinicians in each physician's own medical specialty. It is understood that medical science is always advancing in content and method. As such, what constitutes optimum diagnosis, treatment, and well care is a moving target. The present disclosure provides embodiments of the invention showing how a statistic may be developed and implemented to provide physicians reference for self-guidance and improvement, and the invention contemplates a variety of statistics which may be used for such purposes in other embodiments of the invention. Thus while some items may be referred to as needed or ideal, the present invention contemplates a variety of different implementations to accommodate advances in medical science and treatments.

Medical practice patterns may be inferred, observed, and measured with a primary reliance on a variety of source metrics, including but not limited to: (1) Morbidity adjusted cost and utilization paid claims data for an enrolled population having linkage of specific patients and specific physicians. Embodiments of PSQE make use of data analysis software including, but not limited to, licensed software packages such as MEDai or Symmetry. It is noted that PSQE's use of paid claims data is only to identify apparent variations from the norm, good and bad, for additional analysis with reference to all other Q-E metrics selected by the PQA Specialty Panel; (2) Clinical data that may be extracted from a focused sample of the medical records created incident to medical care delivery including the recorded results of diagnostic testing and procedures; (3) Physician medical chart notes with details about the patient's history and physical, exam findings, and all other recorded information useful by the physician and other physicians for continuing care; (4) Medical Outcome analysis of patients served; and (5) Physician self-description of his/her own medical practice patterns in response the different kinds of patients and medical issues common to each physician specialty.

In addition, specific metrics for each physician specialty may be determined and included by each PQA Specialty Panel. The relative importance of each metric is also as determined by each PQA Specialty Panel, e.g. prescription drug utilization patterns may be twice as important for a Family Practice physician as it is for a General Surgeon.

The metrics are collected, organized and summarized by Q-E Analysts who receive direction and guidance from the Chair of each PQA specialty Panel. The metrics are arrayed in a consistent format for all physicians in each specialty designation reflecting the distribution of each metric. Each physician receives a written summary of his/her Q-E Index as well as: Each metric that, with that metric's relative weight, composites to the Quality-Efficiency Index (There is an audit trail for each metric that may be accessed by the physician receiving the Q-E Index); What specific changes in medical practice patterns are expected to result in improved quality and cost efficiency of medical care services—specific and actionable; and All of the entire Q-E process is archived and preserved for a minimum of 10 years and may be easily reproduced as needed.

The Quality-Efficiency Index is a single number that denotes the degree of variation of this physician's medical practice patterns (process by which medical care is delivered to that physician's patients) from optimum medical care as it is known today by recognized clinical leadership in that same physician specialty (also called Best Practices, Gold Standard, Highest Quality Standards).

A Physician's medical practice pattern is multi-dimensional and many physicians are apt to have a variable performance for different medical practice dimensions. The PQA Panel has the task of evaluating overall performance. The degree of variation from the optimum (gold standard) medical practice pattern is a reliable barometer that allows an actuarial estimate of how much this physician's medical practice pattern varies from the average use of health plan benefit dollars (expressed as $ per member/per month) for the same patient morbidity (expressed as a morbidity index) within the same medical community.

The specific components that feed into a Quality-Efficiency Index are governed by: (1) Determination of the metrics that are most relevant for this physician specialty; (2) Methods for consistently accessing these metrics; and (3) The relative importance of each metric, e.g. proper use of inpatient hospital days. The Q-E Index has a confidence limit in excess of 80% with respect to predicting the use of medical care resource in caring for the same patient morbidity index.

A Quality Improvement Plan (QIP) is formalized whenever the Q-E Index depicts a medical practice pattern that falls below a threshold that is typically based on the average Q-E Index of that medical community, for example 0.70. The physician has pre-agreed by his/her membership terms in the Physician Quality Alliance (PQA) to maintain a minimum Q-E Index of 0.70. The QIP is mutually established by the individual physician and the Chair of the PQA Panel, and ratified by the PQA Panel. The content of each individual Plan involves those actions that may reasonably be expected to remedy each observed metric to the extent that the composite of all metrics, expressed, as the Q-E Index, is expected to be above the threshold, e.g., 0.70. The QIP may involve a different diagnostic or treatment approach to a problematic patient type or medical condition, specific additional training or whatever is mutually established. A reasonable time frame for completing the actions specified in the QIP is also mutually established. In some embodiments, particular measured quantities are individually selected and compared to normative values to indicate if a particular physician's results from use of a particular diagnostic approach or treatment deviates substantially and thus indicate an area for physician education and/or training. Similarly, measured quantities individually selected relating to patient type or medical condition may be individually selected and compared to normative values to indicate if the results for a particular physician for a particular patient type or medical condition deviates substantially and thus indicates an area for physician education and/or training. In other embodiments, measured quantities are selected by identifying those having the greatest total amount of possible improvement of the Q-E Index for that physician.

Physicians may choose not to join the PQA. Failure to achieve a minimum of the threshold Q-E Index value, e.g., 0.70, results in termination of the physician's membership in the Physician Quality Alliance (PQA), subject to appeal and due process.

One embodiment of the Quality-Efficiency Index involves the following sources from which various metrics are being provided: (1) Morbidity-adjusted paid claims data, cost-utilization reports; (2) Compare “expected” cost (patient morbidity-adjusted) with actual cost; (3) Identify statistically significant variations in cost from the norm, apparently “good” or “bad” variations, allowing “drill down” analysis of the factor(s) driving the abnormal values; (4) Medical Chart abstracting, hospital and office, retrospective analysis of all aspects of patient care compared with optimum/quality standards of care, to understanding factors that drive abnormal values for other Q-E Metrics, apparently “good” or “bad”; and/or (5) Physician self-description of medical practice patterns, supported or contradicted by other Q-E Metrics, especially medical chart abstracting.

Below is disclosed a table having one possible Q-E Index Determination:

| | Default Q-E Metrics | | | |
|---|---|---|---|---|
| Internal Medicine as Primary Care | Individual | Individual | | Composite |
| Q-E Metric | Weight Value | Q-E Index | | Q-E Index |
| Medical Outcomes from Clinical Data | 50 | 30 | 0.60 | 0.08 |
| Patient Self-reported Medical Outcomes | 15 | 5 | 0.33 | 0.01 |
| Correct diagnosis | 50 | 28 | 0.56 | 0.07 |
| Appropriate use of Diagnostic Procedures | 15 | 10 | 0.67 | 0.03 |
| Cost of Medical Services Ordered | 15 | 12 | 0.80 | 0.03 |
| Correct Treatment Plan | 50 | 30 | 0.60 | 0.08 |
| Patient Education; Alternative Treatments | 10 | 10 | 1.00 | 0.03 |
| Adequate Attention to Patient Issues | 15 | 15 | 1.00 | 0.04 |
| Patient Education, chronic illness, compliance | 20 | 15 | 0.75 | 0.04 |
| Appropriate Use of IP Hospital | 25 | 15 | 0.60 | 0.04 |
| Discharge Planning & Coordination | 15 | 13 | 0.87 | 0.03 |
| Quality & Cost of Referral Patterns | 25 | 10 | 0.40 | 0.03 |
| Appropriate & Timely Referral of Patient | 25 | 10 | 0.40 | 0.03 |
| Proper use of Rx & Cost of Rx | 25 | 15 | 0.60 | 0.04 |
| Appropriate use of ER by Patient | 10 | 7 | 0.70 | 0.02 |
| Adequacy of Well Care Evaluation of Patient | 10 | 8 | 0.80 | 0.02 |
| Adequacy of Patient Coverage/Availability of Physician | 20 | 18 | 0.90 | 0.05 |
| Patient Satisfaction Survey | 5 | 5 | 1.00 | 0.01 |
| TOTAL | 400 | 256 | | 0.64 |

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method for improving physician performance in measured areas, the method comprising the steps of:
establishing a quantitative measure of a particular type of physician including compiling a plurality of quantitative measures for the particular type of physician and calculating at least one threshold statistical value for the particular type of physician;
monitoring a particular physician relating to the quantitative measures of the particular type of physician of the particular physician;
calculating a score of the particular physician based on the plurality of quantitative measures and comparing the calculated score to the threshold statistical value; and
performing an action relating to the particular physician based on a comparison of the calculated score and the threshold value.

2. The method of claim 1 wherein the action taken in the performing step includes enhancing compensation of the particular physician if the comparison results in determining that the calculated score exceeds the threshold vale.

3. The method of claim 1 wherein the action taken in the performing step includes providing an improvement plan to the particular physician if the comparison results in determining that the calculated score is below the threshold value.

4. The method of claim 1 wherein the action taken in the performing step includes identifying a different diagnostic or treatment approach to a problematic patient type or medical condition for the particular physician.

5. The method of claim 1 wherein the monitoring step involves extracting clinical data from medical records relating to a medical care incident of the plurality of data collected relating to the particular physician including recorded results of medical diagnostic testing.

6. The method of claim 1 wherein the step of calculating further includes the step of creating an audit trail, the audit trail including portions of medical records relating to at least one of the quantitative measures.

7. The method of claim 1 wherein the step of calculating further includes the step of individually selecting particular measured quantities and comparing the particular measured quantities to normative values to indicate if the results of the particular physician relating to the use of a particular diagnostic approach deviates substantially to thereby indicate an area for physician education and/or training.

8. The method of claim 7 wherein the step of performing an action includes creating a quality improvement plan that includes indication of an area for physician education and/or training relating to the particular physician results for the particular diagnostic approach that deviates substantially.

9. The method of claim 1 wherein the step of calculating further includes the step of individually selecting particular measured quantities and comparing the particular measured quantities to normative values to indicate if the results of the particular physician relating to the use of a particular treatment deviates substantially to thereby indicate an area for physician education and/or training.

10. The method of claim 9 wherein the step of performing an action includes creating a quality improvement plan that includes indication of an area for physician education and/or training relating to the particular physician results for the particular treatment that deviates substantially.

11. The method of claim 1 wherein the step of calculating further includes the step of individually selecting particular measured quantities and comparing the particular measured quantities to normative values to indicate if the results of the particular physician relating to a particular patient type deviates substantially to thereby indicate an area for physician education and/or training.

12. The method of claim 11 wherein the step of performing an action includes creating a quality improvement plan that includes indication of an area for physician education and/or training relating to the particular physician results for the particular patient type that deviates substantially.

13. The method of claim 1 wherein the step of calculating further includes the step of individually selecting particular measured quantities and comparing the particular measured quantities to normative values to indicate if the results of the particular physician relating to a particular medical condition deviates substantially to thereby indicate an area for physician education and/or training.

14. The method of claim 13 wherein the step of performing an action includes creating a quality improvement plan that includes indication of an area for physician education and/or training relating to the particular physician results for the particular medical condition that deviates substantially.

15. The method of claim 1 wherein said establishing step is periodically performed to update the threshold value periodically.

16. The method of claim 1 wherein the monitoring step is periodically performed to update the quantitative measures for the calculating step.

17. The method of claim 1 wherein the monitoring step includes monitoring at least one of observed morbidity adjusted cost and utilization paid claims data for an enrolled population, the monitoring step recording the linkage of specific patients and specific physicians.

18. The method of claim 1 wherein the monitoring step includes monitoring at least one of clinical data extracted from a focused sample of the medical records created incident to medical care delivery, and recorded results of diagnostic testing and procedures.

19. The method of claim 1 wherein the monitoring step includes monitoring at least one of physician medical chart notes about patient history, physical, exam findings, and recorded information used by physicians for continuing care.

20. The method of claim 1 wherein the monitoring step includes monitoring at least one of medical outcome analysis of patients served and physician self-description.
